(19) United States
(12) Patent Application Publication
(10) Pub. No.: US 2026/0001596 A1
(43) Pub. Date: Jan. 1, 2026

(54) TRAILER WITH COLLAPSIBLE SIDE RAILS

(71) Applicant: American Trailer World Corp., Addison, TX (US)

(72) Inventors: Scott A. Storz, Westminster, SC (US); Paul Smith, Lavonia, GA (US); Gurucharan Vasa, Jadcherla (IN); Dasari Venkata Chiranjeevi, Cherukupalli (IN)

(21) Appl. No.: 18/758,254

(22) Filed: Jun. 28, 2024

(51) Int. Cl. B62D 33/03

(52) U.S. Cl. CPC B62D 33/03

(57) ABSTRACT

A trailer comprising a base frame and a side-rail assembly secured to the base frame. The side-rail assembly comprises at least one top rail and at least one support element extending between the top rail and the base frame. The side-rail assembly is configured to shift between an erected configuration and a collapsed configuration. In the erected configuration, the top rail is positioned vertically above and spaced apart from the base frame. In the collapsed configuration, the top rail is positioned adjacent to the base frame.

### FIELD

Embodiments of the present invention are generally directed to trailers. More particularly, embodiments of the present invention are directed to trailers with side rails that can be selectively shifted between erected and collapsed configurations.

### RELATED ART

Trailers are commonly used in conjunction with vehicles to transport payloads. Efficient shipping of trailers is a high priority for trailer manufacturers, as shipping costs can be a significant expense. Often, after manufacture, trailers will be shipped on semi-haulers to their intended destinations. The more trailers that can fit on a given semi-hauler for shipping will reduce the overall expense for the manufacturer.

Thus, it would be beneficial if trailers could be formed with adjustable components that could make the trailers more compact when the trailers need to be shipped. In addition, it would be beneficial if such adjustable components would also permit the trailers to be selectively configured to more efficiently load and unload payloads into and out of the trailers.

### SUMMARY

To address the above-described challenges, embodiments of the present invention provide a trailer comprising a collapsible side-rail assembly that can be selectively positioned in an erected configuration for normal use and in a collapsed configuration for shipping and/or for loading and unloading of payloads. For example, to transport two or more trailers according to embodiments of the present invention, the side-rail assemblies of the trailers can be shifted from an erected configuration to a collapsed configuration such that the trailers can be nested together for shipping. Once the trailers have reached their intended destination, the trailers can be un-nested, and the side-rail assemblies of the trailers can be shifted to the erected configuration for normal use by a user. Furthermore, the user of an individual trailer can selectively shift the side-rail assembly of the trailer from the erected configuration to the collapsed configuration to facilitate efficient loading and unloading of payloads from the trailer.

In more detail, embodiments of the present invention include a trailer comprising a base frame and a side-rail assembly secured to the base frame. The side-rail assembly comprises at least one top rail and at least one support element extending between the top rail and the base frame. The side-rail assembly is configured to shift between an erected configuration and a collapsed configuration. In the erected configuration, the top rail is positioned vertically above and spaced apart from the base frame. In the collapsed configuration, the top rail is positioned adjacent to the base frame.

Embodiments of the present invention additionally include a trailer comprising a base frame and a side-rail assembly secured to the base frame. The side-rail assembly comprises at least one top rail and at least two support elements extending between the top rail and the base frame. The side-rail assembly is configured to shift between an erected configuration and a collapsed configuration. In the erected configuration, the top rail is positioned vertically above and spaced apart from the base frame. During a transition between the erected configuration and the collapsed configuration, the top rail is configured to shift forwardly and downwardly.

Embodiments of the present invention further include a method of using a trailer. The method comprises a number of steps. One step includes providing the trailer comprising a base frame and a side-rail assembly secured to the base frame. The side-rail assembly comprises at least one top rail and at least one support element extending between the top rail and the base frame. An additional step includes maintaining the side-rail assembly in an erected configuration in which the top rail is positioned vertically above and spaced apart from the base frame. A further step includes shifting the side-rail assembly to a collapsed configuration in which the top rail is positioned adjacent to the base frame.

This summary is not intended to identify essential features of the present invention, and is not intended to be used to limit the scope of the claims. These and other aspects of the present invention are described below in greater detail.

### BRIEF DESCRIPTION OF THE DRAWINGS

Embodiments of the present invention are described in detail below with reference to the attached drawing figures, wherein:

FIG. 1 is a front perspective view a trailer according to embodiments of the present invention, with a side-rail assembly in an erected configuration;

FIG. 2 is a rear perspective view of the trailer from FIG. 1;

FIG. 3 is a front perspective view of the trailer from FIGS. 1 and 2, with a ramp of the trailer in a lowered position;

FIG. 4 is a rear perspective view of the trailer from FIG. 3;

FIG. 5 is a front perspective view of the trailer from FIGS. 1 and 2, with the side-rail assembly shifted to the collapsed configuration;

FIG. 6 is a rear perspective view of the trailer from FIG. 5;

FIG. 7 is a perspective view of a plurality of trailers nested together for transport according to embodiments of the present invention;

FIG. 8 is an enlarged view of a left rear portion of the trailer from FIGS. 1 and 2, particularly illustrating the side-rail assembly being maintained in the erected configuration via a locking mechanism;

FIG. 9 is another enlarged view of the portion of the trailer from FIG. 8, particularly illustrating the side-rail assembly being maintained in the collapsed configuration via the locking mechanism;

FIG. 10 is an enlarged view of a left front portion of the trailer from FIGS. 1 and 2, particularly illustrating the side-rail assembly being maintained in the erected configuration via a locking mechanism according to another embodiment of the present invention;

FIG. 11 is another enlarged view of the portion of the trailer from FIG. 10, particularly illustrating the side-rail assembly being maintained in the collapsed configuration via the locking mechanism; and

FIG. 12 is an enlarged view of a left side of the trailer from FIGS. 5 and 6, with a fender shown removed from a base frame of the trailer.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

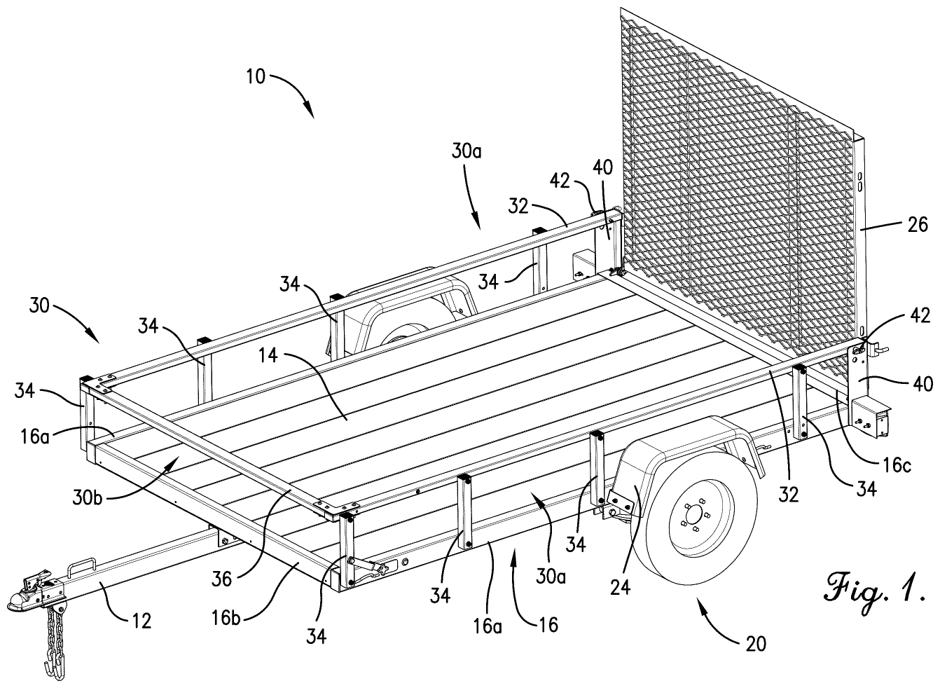

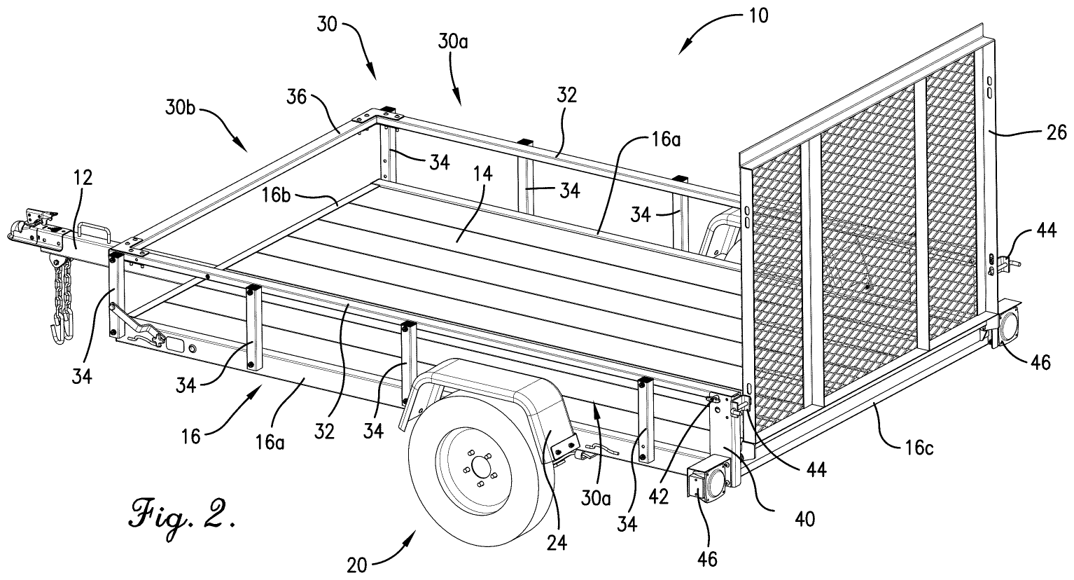

With reference to the figures, and particularly to FIGS. 1 and 2, embodiments of the present invention are broadly directed to a utility trailer 10 (referred to herein as the “trailer”), configured to be hitched to the rear of a motor vehicle (not shown) via a towbar 12. The trailer 10 may comprise a main section 14, which may form a bed or deck for supporting cargo. The main section 14 may include a base frame 16 extending around a perimeter of the main section 14. In some embodiment, the base frame 16 will be generally rectangular, comprising a pair of side frame elements 16a, a front frame element 16b, and a rear frame element 16c. Such frame elements 16a, b, c, may be formed from square, steel tubing and interconnected via welding, fasteners, or the like.

Relational and/or directional terms, such as “above”, “below”, “up”, “upper”, “upward”, “down”, “downward”, “lower”, “top”, “bottom”, “outer”, “inner”, “front”, “forward,” “back”, “rear”, “rearward”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. For example, with reference to FIG. 1, the front of the trailer 10 is shown in the lower left corner of the figure towards the towbar 12, while the rear of the trailer 10 is shown in the upper right corner of the figure. Embodiments of the technology may be positioned, oriented, and/or aligned in other ways or move in other directions. Therefore, the terms do not limit the scope of the current technology.

Remaining with FIGS. 1 and 2, the main section 14 may, in some embodiment, comprise a platform (e.g., formed from wood paneling) that is positioned on and/or supported by the base frame 16 to present a bed/deck for supporting payloads. As such, the main section 14 may present a cargo area on which payloads can be supported.

The trailer 10 may be supported on the ground by a pair of wheels 20 connected via a single axle. The axle may be attached to the main section 14 and/or to the base frame 16 via a suspension system (e.g., a spring-type suspension system). Each wheel 20 may be provided with a protective wheel fender 24 that is also connected to the main section 14 and/or the base frame 16 (as discussed in more detail below). In alternative embodiments, the trailer 10 may be configured as a multi-axle trailer.

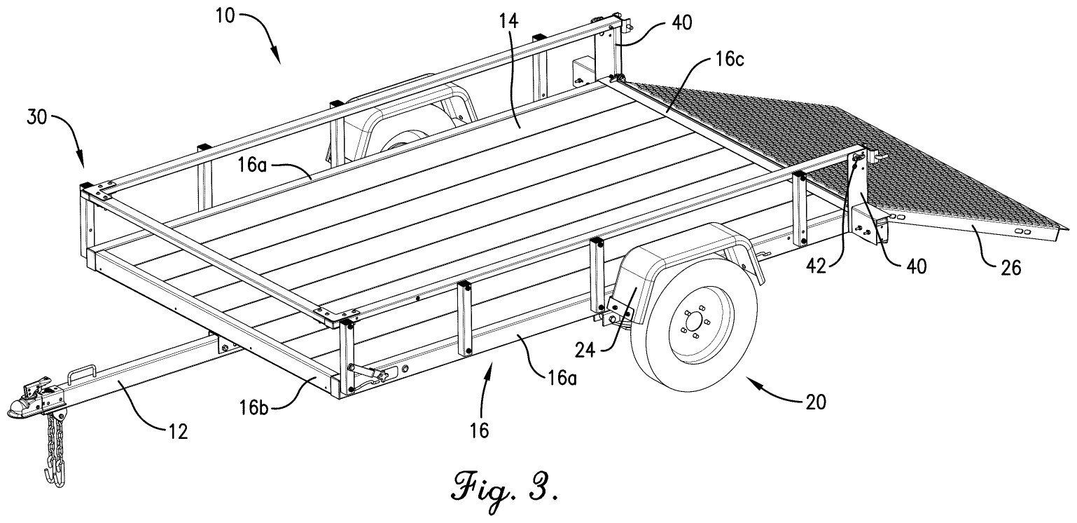

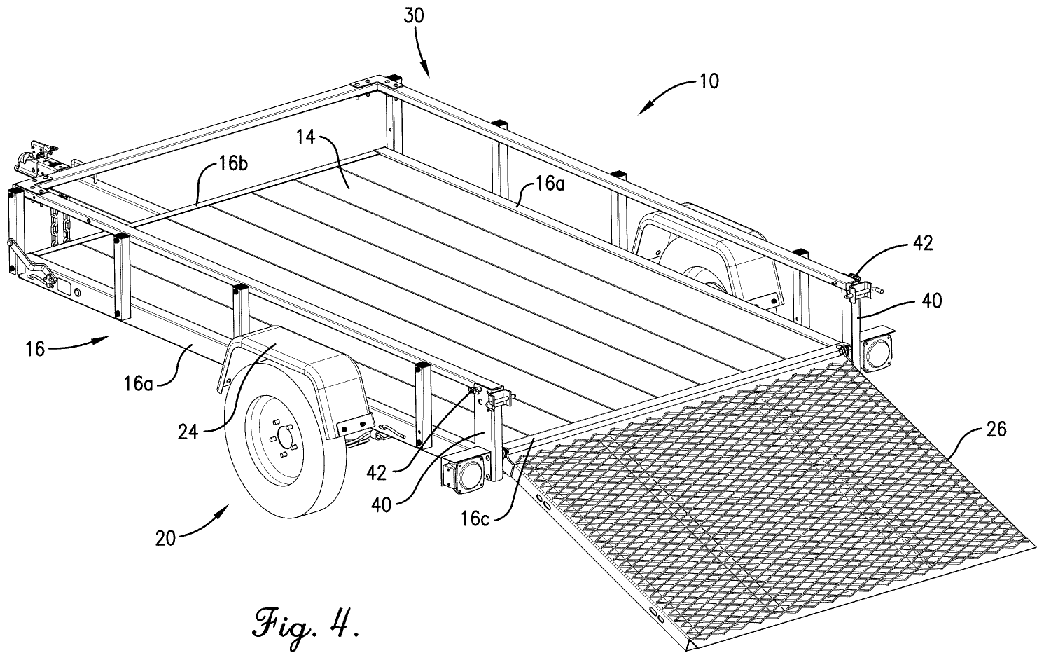

The towbar 12 extends forward from the main section 14 and is configured to be attached to a vehicle for pulling the trailer 10. A rotatable ramp 26 may be rotatably secured to a back end of the trailer 10 (e.g., to the rear frame element 16c). In a lowered position, as shown in FIGS. 3 and 4, the ramp 26 may facilitate loading and unloading of a payload to/from the trailer 10. In a raised position, as shown in FIGS. 1 and 2, the ramp 26 may act as a gate or tailgate to keep the payload secured in or on the trailer 10. In some embodiment, the ramp 26 may be used in place of a rear frame element 16c of the base frame 16.

Finally, as illustrated in FIGS. 1-4, the trailer 10 may include a side-rail assembly 30 that extends at least partially around the perimeter of the cargo area of the trailer 10. In some embodiments, the side-rail assembly 30 may extend upward from one or more of the frame elements 16a, 16b, 16c of the base frame 16. As such, the side-rail assembly 30 will at least partially enclose the cargo area of the trailer 10. In more detail, the side-rail assembly 30 may comprise a pair of side portions 30a, a front portion 30b, and a rear portion. In embodiments of a trailer 10 that includes the ramp 26, as shown in the figures, the side-rail assembly 30 may not include a rear portion, such that the side-rail assembly 30 may only include pair of side portions 30a and a front portion 30b.

In more detail, each of the side portions 30a of the side-rail assembly 30 may comprise an elongated top rail 32 and a plurality of support elements 34 (e.g., uprights) extending from the top rail 32. The top rails 32 may, in some embodiments, each be formed from square, steel tubing and may generally extend in a longitudinal direction in general alignment with one of the side frame elements 16a of the base frame 16.

The support elements 34 may each similarly be formed from elongated section of square, steel tubing, and may comprise a first end (i.e., a top end) rotatably coupled to a respective top rail 32, and an opposite, second end (i.e., a lower end) rotatably coupled to a respective side frame element 16a of the base frame 16. The side-rail assembly 30 may include various numbers of support elements 34 for supporting each of the top rails 32 with respect to the base frame 16. For example, as shown in the drawings, each top rail 32 may be connected to a respective side frame element 16a via four support elements 34. However, it should be understood that more or fewer than four support elements 34 may be used. Additionally, the top rails 32 and the support elements 34 may, in some embodiments, be formed with designs other than square tubing, such as angle bars, rectangular tubes, stamped or formed plate, or the like.

Each of the support elements 34 may be rotatably secured to a respective top rail 32 and/or to a respective side frame element 16a by various types of connection assemblies that provide for rotatable connections. For example, in some embodiments, each of the support elements 34 may include a through-hole that is aligned with a through-hole in a respective top rail 32. A rivet nut may be inserted within the through-hole formed in the top rail 32, and the top end of the support element 34 may be rotatable connected to the top rail 32 via a shoulder bolt extending through the through-hole formed in the support element 34 and threadedly-engaged with the rivet nut. Similarly, a bottom end of the support element 34 may be rotatable connected to the side frame element 16a via a shoulder bolt extending through a through-hole formed in the support element 34 and that is threadedly-engaged with a rivet nut engaged within a through-hole formed in the side frame element 16a. The through-holes formed in the side frame elements 16a, the top rails 32, and/or the support elements 34 may have various shapes, such as round, square, rectangular, pentagonal, hexagonal, octagonal, or the like. The rivet nuts may also have various shapes corresponding with the shapes of the through-holes, such as round, square, rectangular, pentagonal, hexagonal, octagonal, or the like. For example, in some embodiments the through-holes formed in the top rails 32 and/or the side frame elements 16a may be hexagonally shaped so as to securely receive and to prevent rotation of hexagonally-shaped rivet nuts.

In addition to or in place of rivet nuts, weld nuts may be rigidly attached (e.g., welded) to the top rails 32 and/or the side frame elements 16a via a clearance hole. Alternatively, in place of rivet nuts or weld nuts, a thread cut could be formed directly into the top rail 32 and/or the side frame elements 16a. Furthermore, in addition or alternatively to shoulder bolts, the connection assemblies may include huck bolts, threaded bolts, rivets, or the like. Furthermore still, in some embodiments, washers may be used as part of the connection assemblies to create fixed gaps between moving parts. For example, lock washers may be used, but the washers could alternatively consist of metallic or plastic flat washers, Belleville washers, or other spring washers.

In still further embodiments, intermediate components may be used between the support elements 34 and the top rails 32 and/or side frame elements 16a to provide the rotatable connection. Such intermediate components may include studs that are welded to the top rails 32 and/or to the side frame elements 16a. As such, the support elements 34 may be attached to the studs using regular or locking nuts. Thus, the support elements 34 may be rotatably connected to the studs, and/or the studs could be rotatably connected to the top rails 32 or side frame elements 16a. In some other embodiments, the connection assemblies may be formed directly as part of the side frame elements 16a, the top rails 32, and/or the support elements 34 (e.g., stamped directly into the side frame elements 16a, the top rails 32, and/or the support elements 34). In other embodiments, the connection assemblies may comprise stamped or machined parts that are configured to be rotatably connected to the side frame elements 16a, to the top rails 32, and/or to the support elements 34. In some embodiments, such stamped or machined parts may be rigidly secured to the side frame elements 16a and/or top rails 32 (e.g., via welding) and rotatably connected to the support elements 34. Finally, protective caps may be applied to top and/or bottom ends of the support elements 34 to enclose the support elements 34 and prevent debris or environmental contamination from entering the interior of the support elements 34.

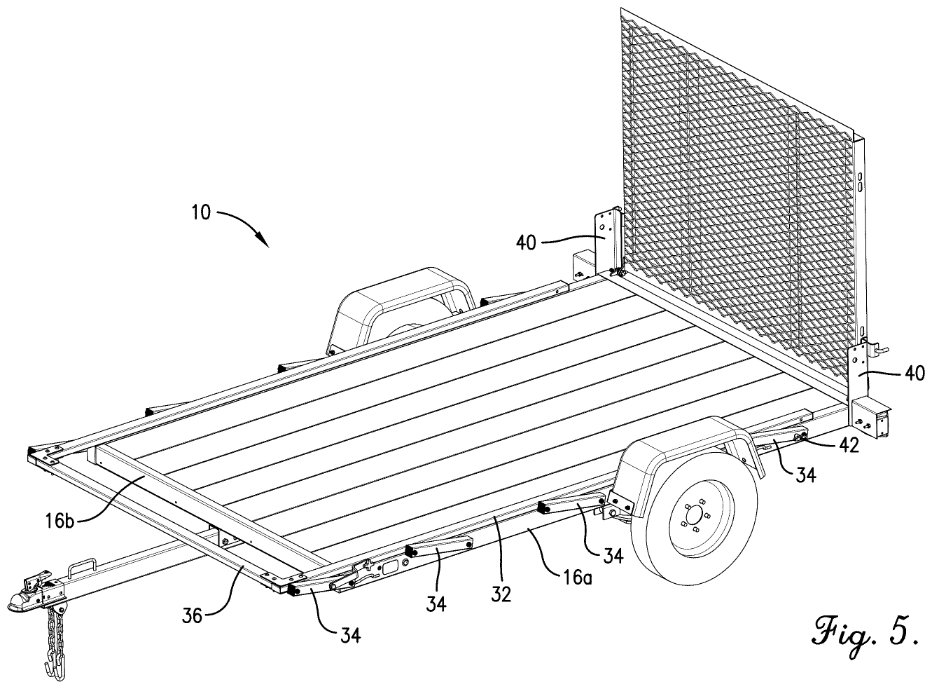

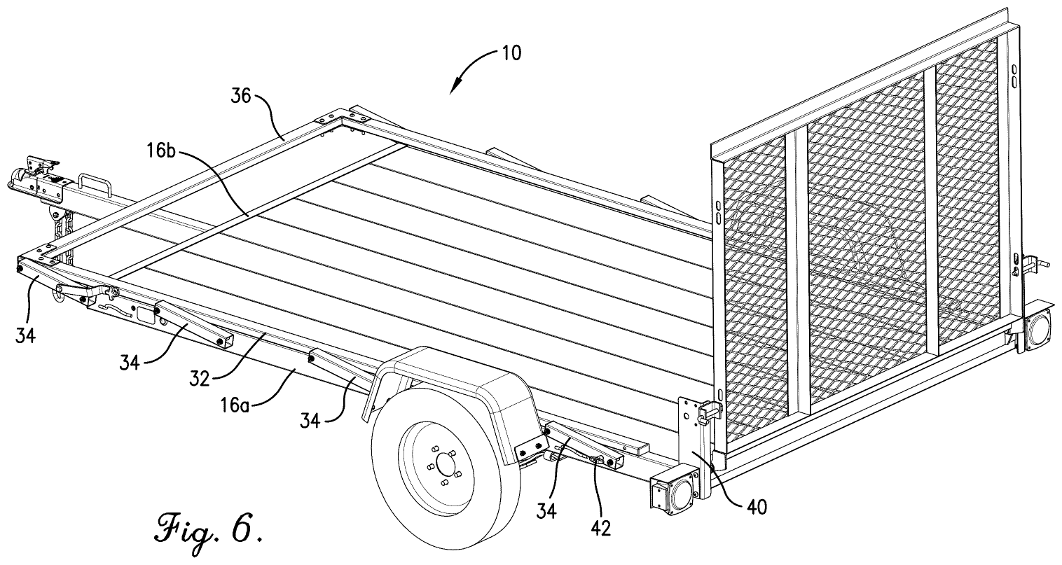

As will be described in more detail below, the side-rail assembly 30 of the trailer 10 is configured to transition between an erected configuration (see FIGS. 1-4) and a collapsed configuration (see FIGS. 5 and 6). When the side-rail assembly 30 is in the erected configuration, each of the support elements 34 will extend generally vertically, in a downward direction from the respective top rail 32 to the respective side frame element 16. In contrast, when the side-rail assembly 30 is in the collapsed configuration, each of the support elements 34 will extend in a downward direction, about a non-perpendicular angle (e.g., in a rearward direction) from the top rails 32 to the respective side frame element 16.

The front portion 30b of the side-rail assembly 30 may comprise a crossbar 36 that may, in some embodiments, be an elongated section formed from square, steel tubing and may generally extend in a lateral direction in general alignment with the front frame element 16b of the base frame 16 (particularly when the side-rail assembly 30 is in the erected configuration). In some embodiments, the crossbar 36 may extend between front ends of the top rails 32 of the side portions 30a of the side-rail assembly 30. The crossbar 36 may be rigidly secured to the top rails 32 via fasteners, brackets, welding or the like.

The side-rail assembly 30, as described above, is configured to be selectively transitioned between an erected configuration (i.e., FIGS. 1-4) and a collapsed configuration (i.e., FIGS. 5 and 6). Such an ability is generally facilitated via the rotatable connections between the support elements 34 and the top rails 32, as well as the rotatable connections between the support elements 34 and the side frame elements 16a. In the erected configuration, each of the top rails 32 is spaced apart, vertically above a respective side frame element 16a. Specifically, in the erected configuration, each of the top rails 32 may be generally aligned with (e.g., parallel to) its respective side frame element 16a, such that a front end of the top rail 32 is laterally and longitudinally aligned with a front end of the side frame element 16a, and such that a rear end of the top rail 32 is laterally and longitudinally aligned with a rear end of the side frame element 16a. Similarly, in the erected configuration, the crossbar 36 is spaced apart, vertically above the front frame element 16b. Specifically, in the erected configuration, the crossbar 36 may be generally aligned with (e.g., parallel to) the front frame element 16b, such that a right end of the crossbar 36 is laterally and longitudinally aligned with a right end of the front frame element 16b, and such that a left end of the crossbar 36 is laterally and longitudinally aligned with a left end of the front frame element 16a.

Although the above examples describe how, in the erected configuration, the top rails 32 may be positioned “directly,” vertically above the side frame elements 16a (i.e., such that the top rails 32 are laterally and longitudinally aligned with the side frame elements 16a) and how the crossbar 36 may be positioned “directly,” vertically above the front frame element 16b (i.e., such that the crossbar 36 is laterally and longitudinally aligned with the front frame element 16b), the top rails 32 and the crossbar 32 need not be positioned directly, vertically above the frame elements 16a,b when the side-rail assembly 30 is in the erected configuration. For example, the top rails 32 may, in the erected configuration, be positioned vertically above the side frame elements 16a but may be laterally (e.g., inboard/outboard) and/or longitudinally offset from the side frame elements 16a such that the top rails 32 are not completely laterally and longitudinally aligned with the side frame elements 16a. Nevertheless, in some embodiments, the top rails 32 may still be oriented in a parallel manner with the side frame elements 16a. Similarly, the crossbar 36 may, in the erected configuration, be positioned vertically above the front frame element 16b but may be laterally (e.g., inboard/outboard) and/or longitudinally offset from the front frame element 16b such that the crossbar 36 is not completely laterally and longitudinally aligned with the front frame element 16b. Nevertheless, in some embodiments, the crossbar 36 may still be oriented in a parallel manner with the frame frame element 16b. Thus, as used herein, the term “vertically above” simply means that a first component is positioned vertically higher than a second component. If the intent is for the first component to be vertically higher than the second component, as well as laterally and longitudinally aligned with second component, then the term “directly” vertically above is used herein.

As the side-rail assembly 30 transitions from the erected configuration to the collapsed configuration, each of the top rails 32 and the crossbar 36 move in a forward and a downward direction, with such movement being facilitated by the rotatable connections of the support elements 34. In the collapsed configuration, each of the top rails 32 is positioned adjacent to a top surface of a respective side frame element 16a. Specifically, a bottom surface of each of the top rail 32 may be adjacent to and/or in contact with a top surface of a respective side frame element 16a. The top rails 32 may still be positioned parallel to a respective side frame element 16a. However, because the top rails 32 are shifted forward in addition to downward, front ends of the top rails 32 are shifted forward in front of the front ends of the side frame elements 16a. Similarly, rear ends of the top rails 32 are shifted forward from the rear ends of the side frame elements 16a.

Correspondingly, in the collapsed configuration, the crossbar 36 is spaced forward from the front frame element 16b, with a bottom surface of the crossbar 36 being very near to or equal to a vertical position of a top surface of the front frame element 16b. As such, the right end of the crossbar is positioned forward of the right end of the front frame element 16b, and the left end of the crossbar 36 is positioned forward of the left end of the front frame element 16b.

The ability of the side-rail assembly 30 to transition between the erected configuration and the collapsed configuration provides various benefits. In the erected configuration, the side-rail assembly 30 can at least partially surround the cargo area of the trailer 10, so as to provide support for and to securely hold payloads within the cargo area. Specifically, the top rails 32 and the crossbar 36 may be supported, via the support elements 34, above the main section 14 and/or above the base frame 16 of the trailer 10 to at least partially surround the cargo area and to provide support for payloads held within the cargo area.

In contrast, in the collapsed configuration of the side-rail assembly 30, the side-rail assembly 30 is rotated forward and downward such that the top rails 32, the crossbar 36, and the support elements 34 are positioned adjacent to a top surface of the main section 14 and/or of the base frame 16 of the trailer 10. Thus, in the collapsed configuration, the top rails 32, the crossbar 36, and the support elements 34 are positioned adjacent to and not spaced vertically above the main section 14 and/or the frame 16 by a significant amount (e.g., no more than twelve inches, no more than ten inches, no more than eight inches, no more than six inches, four inches, two inches, or one inch above the main section 14 and/or the base frame 16). As a result, the collapsed side-rail assembly 30 provides a unique pathway for payloads to be efficiently loaded or unloaded from the cargo area of the trailer 10, e.g., from the lateral sides or from the front of the trailer 10. Specifically, because the payloads do not have to be raised to a significant height to clear the top rails 32 when the side-rail assembly 30 is in the collapsed configuration, a user can efficiently and safely load and unload payloads to/from the trailer 10 via the lateral sides or the front of the trailer.

In some embodiments, once a payload has been loaded onto cargo area of the trailer 10, the side-rail assembly 30 can be shifted back to the erected configuration to provide support for and stability of the payload within the cargo area during transport of the payload. However, for some oversized payloads, the side-rail assembly 30 may be maintained in the collapsed configuration during transportation of such payloads. Regardless, in some embodiments, when a trailer 10 has been used to transport a payload to an intended destination, the side-rail assembly 30 may be translated from the erected configuration (as used to transport) to the collapsed configuration to facilitate efficient unloading of the payload.

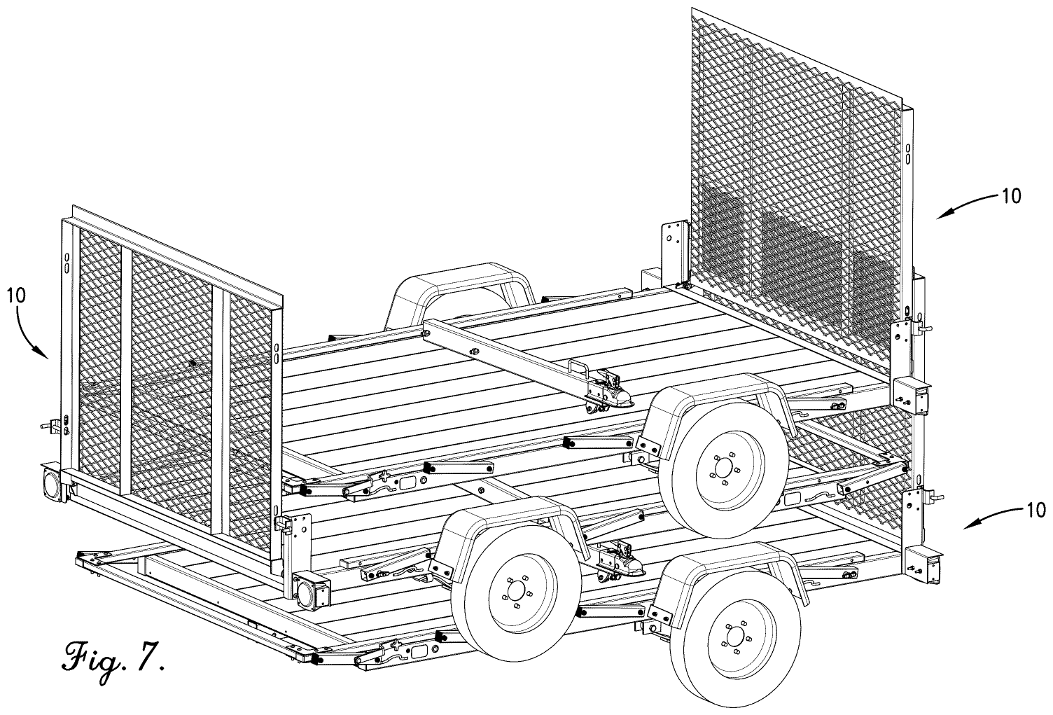

In addition to providing improved loading and unloading capabilities, the collapsible side-rail assembly 30 may enhance the ability of multiple trailers to be shipped together. For example, a plurality of trailers 10 with their respective side-rail assemblies 30 in the collapsed configuration can be nested together in a compact manner, as illustrated in FIG. 7, to facilitate efficient shipping of the trailers 10. Specifically, shifting the side-rail assemblies 30 of a group of trailers 10 from the erected configuration to the collapsed configuration will reduce the height of at least a portion of each of the trailers 10, so as to permit the group of trailers 10 to be nested together in a compact manner for shipping. Although FIG. 7 illustrates three trailers 10 nested together, it is understood that other numbers of trailers 10 may be nested together, such as two, four, five, six, seven, or more trailers 10. In some embodiments, the towbars 12 of the trailers 10 may be removed to increase compactness of the nested trailers 10. Although the figure illustrates the ramps 26 of the trailers being in the raised position, it is possible that the ramps 26 could be removed or could be rotated inward so as to lay on top of the main sections 14 of the trailers. Regardless, it is noted that the side-rail assembly 30 and the ramp 26 of a given trailer are configured to translate independently of each other.

Embodiments of the present invention provide various types of locking mechanisms that can be used to securely maintain the side-rail assemblies 30 in either the erected configuration or the collapsed configuration. In more detail, and with reference to FIGS. 1-6, the trailer 10 may include a pair of base brackets 40 positioned on the rear end of the trailer 10, with one base bracket 40 positioned on each lateral side of the trailer 10. The base brackets 40 may each comprise a section of L-shaped material (e.g., steel) with a bottom end rigidly secured to one of the side frame elements 16a, towards a rear end of the side frame element 16a. The base brackets 40 may extend upward from the respective side frame element 16a to a position adjacent to one of the top rails 32 when the side-rail assembly 30 is in the erected configuration. Thus, the base brackets 40 remain securely in place with respect to the base frame 16 of the trailer 10 as the side-rail assembly 30 shifts between the erected and collapsed configurations.

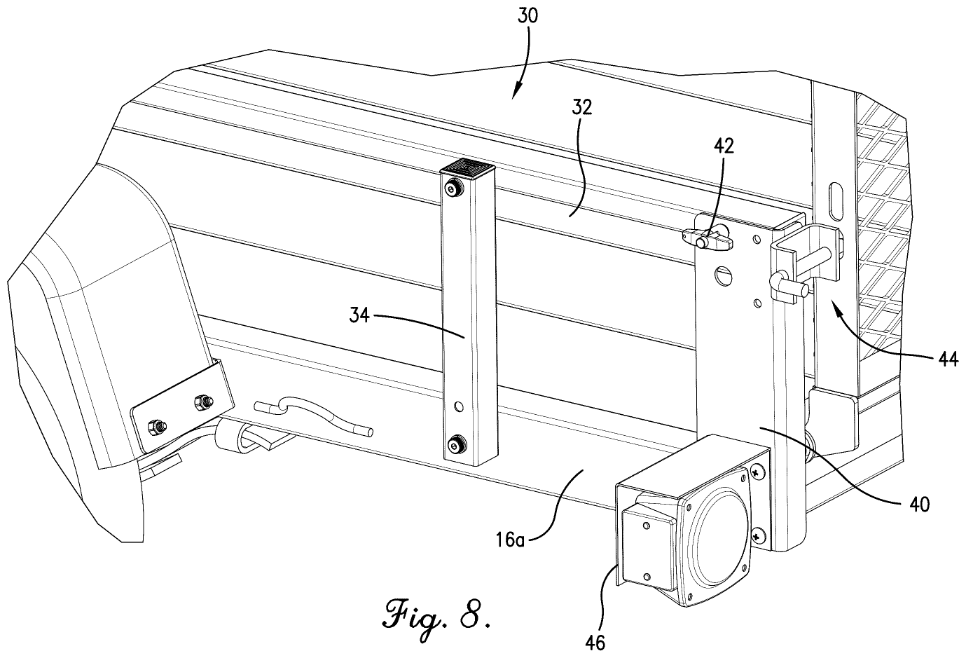

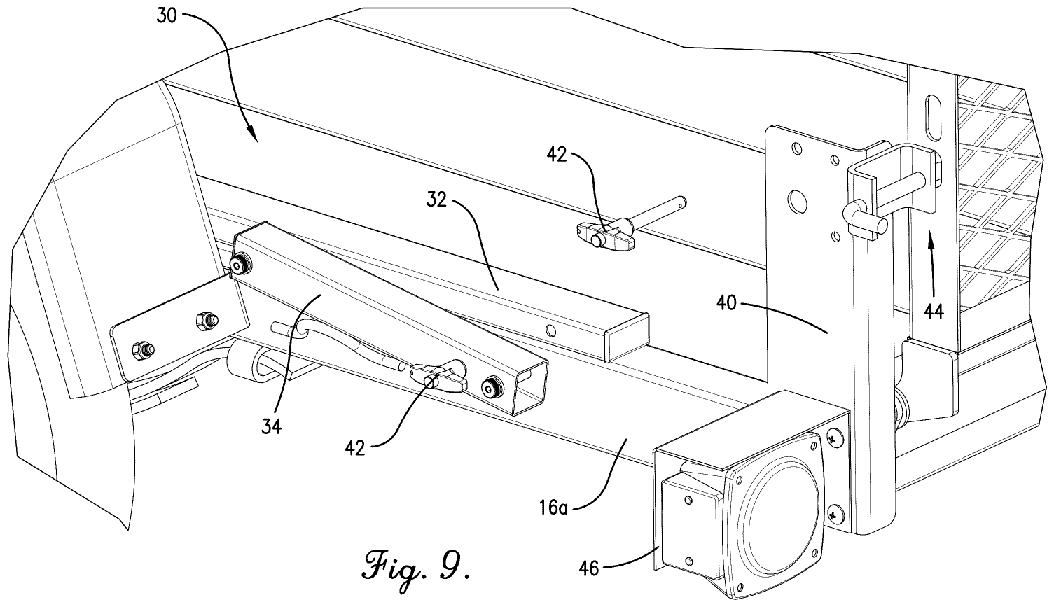

As illustrated in FIGS. 1-4, a locking mechanism in the form of a spring pin 42 may be removably inserted through a pair of aligned through-holes formed in each of the left-side base bracket 40 and the left-side top rail 32 when the side-rail assembly 30 is in the erected configuration to maintain the side-rail assembly 30 in the erected configuration. FIG. 8 illustrates the spring pin 42 in more detail, with the spring pin 42 maintaining the side-rail assembly 30 in the erected configuration by securing the top rail 32 to the base bracket 40. As perhaps best illustrated in FIG. 9, the spring pin 42 may include an elongated rod with a spring actuated locking function that is released upon pressing a release button on a t-handle portion of the spring pin 42. A similar spring pin 42 may be used to releasably couple the right-side base bracket 40 and the right-side top rail 32. Thus, with the left and right-side spring pins 42 securing the left and right-side base brackets 40 respectively to the left and right-side top rails 32 (see, e.g., FIGS. 1-4), the side-rail assembly 30 will be securely maintained in the erected configuration and cannot be shifted to the collapsed configuration.

When the side-rail assembly 30 is required to be shifted to the collapsed configuration, the left and right spring pins 42 can be removed from the base brackets 40 and the top rails 32, which therefore permits the side-rail assembly 30 to be rotated forward and downward to the collapsed configuration (see, e.g., FIG. 9). To maintain the side-rail assembly 30 in the collapsed configuration, the spring pins 42 may each be removably inserted through a pair of aligned through-holes formed in the respective top rail 32 and the side frame element 16a, as shown in FIGS. 5, 6, and 9. Specifically, with the left and right-side spring pins 42 securing the left and right-side top rails 32 with the left and right-side side frame elements 16a, the side-rail assembly 30 will be securely maintained in the collapsed configuration and cannot be shifted to the erected configuration.

In addition to providing a support component for securing the side-rail assembly 30 in the erected configuration, the base brackets 40 may provide support for latching mechanisms 44 that can be used to releasably secure the ramp 26 in the raised position, as perhaps best shown by FIG. 2. Specifically, each of the left and right-side base brackets 40 may include a latching mechanism 44 positioned on a back side of the base bracket 40 for respectively securing a left side and a right side of the ramp 26 in the raised position. As perhaps best illustrated by FIGS. 8 and 9, the latching mechanisms 44 may be in the form of spring latches, each with an elongated L-shaped latching rod that may be releasably engaged with the ramp 26. Notably, because the base brackets 40 remain securely in place with respect to the base frame 16 of the trailer 10, regardless of whether the side-rail assembly 30 is in the erected or collapsed configurations, the latching mechanisms 44 can maintain the ramp 26 in the raised position regardless of whether the side-rail assembly 30 is in the erected or collapsed configurations.

In addition, each of the let and right-side base brackets 40 may include a light assembly 46 attached to an exterior side of the base bracket 40. The light assembly 46 may include a bracket and a light-emitting device (e.g., LED or bulb) configured selectively direct light rearward, such as may be required for running lights or brake lights for the trailer 10. The bracket of the light assembly 46 may be secured to the base bracket 40 via fasteners, welding, or the like. Each interconnected group of base brackets 40, light assembly 46 bracket, and side frame element 16a may include aligned through-holes to permit electrical wiring to pass through the interior of the side frame element 16a and to the light-emitting device of the light assembly 46.

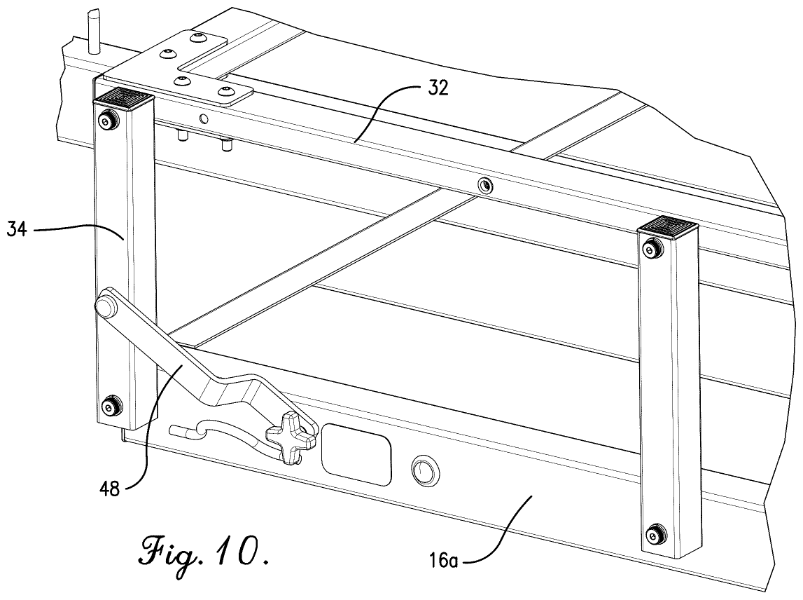

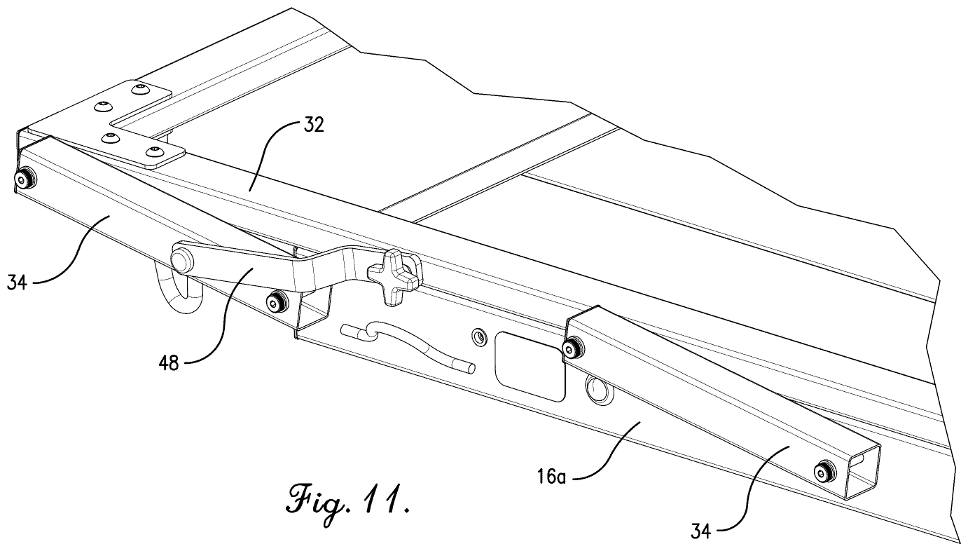

Certain additional embodiments of the present invention may include additional or alternative locking mechanisms for maintaining the side-rail assembly 30 in the erected configuration or in the collapsed configuration. Specifically, with reference to FIGS. 10 and 11, embodiments may include a locking mechanism in the form of an elongated support bar 48. The support bar 48 may be rotatably secured at a first end to the forward-most support element 34 of the side-rail assembly 30 and may be releasably secured at a second end to either the side frame element 16a or to the top rail 32. In more detail, to maintain the side-rail assembly 30 in the erected configuration, as shown in FIG. 10, the second end of the support bar 48 may be secured to the side frame element 16a via a threaded fastener extending through a through-hole formed in the second end of the support bar 48 and a threaded opening (e.g., via a rivet nut) formed in the exterior side of the side frame element 16a. In some embodiments, the threaded fastener may include a handle that permits the fastener to be threaded and unthreaded by hand. Although FIG. 10 shows a left-side support bar 48 securing a left-side of the side-rail assembly 30 in the erected configuration, it is understood that a similar right-side support bar 48 may be used to secure a right-side of the side-rail assembly 30 in the erected configuration. In such a configuration, with the support bars 48 securely positioned between the support elements 34 of the side-rail assembly 30 and the side frame elements 16a, the side-rail assembly 30 will be securely maintained in the erected configuration and cannot be shifted to the collapsed configuration.

When the side-rail assembly 30 is required to be shifted to the collapsed configuration, the left and right support bars 48 can be disengaged from the side frame elements 16a, which therefore permits the side-rail assembly 30 to be rotated forward and downward to the collapsed configuration. Specifically, the fasteners securing the ends of the support bars 48 to the side frame elements 16a can be unthreaded to free the ends of the support element. As such, the side-rail assembly 30 can be shifted to the collapsed configuration. To maintain the side-rail assembly 30 in the collapsed configuration, as shown in FIG. 11, the second ends of the support bars 48 can be secured to the top rails 32. Specifically, the fasteners may extend through the through-hole formed in the second ends of the support bars 48 and into threaded openings (e.g., via rivet nuts) formed in the exterior side of the top rails 32. With the left and right-side support bars 48 securing the forward-most left and right-side support elements 34 of the side-rail assembly 30 respectively with the left and right-side top rails 32, the side-rail assembly 30 will be securely maintained in the collapsed configuration and cannot be shifted to the erected configuration.

In some embodiments, the support bars 48 may be formed from a material having high strength and durability, such as steel. In addition, the support bars 48 may be formed in an S-shape comprising (i) a first elongated, longitudinally-extending section extending from the support element 34, (ii) a second elongated, longitudinally-extending section, and (iii) a relatively shorter, laterally-extending section that extends between the first and second longitudinally-extending sections. In addition to the spring pins 42 and the support bars 48 discussed above, some embodiments of the present invention may provide for other types of locking mechanisms to be used to maintain the side-rail assembly 30 in the erected configuration or in the collapsed configuration, such as clevis pins, r-clips, draw latches, cam latches, over-center latches, or the like.

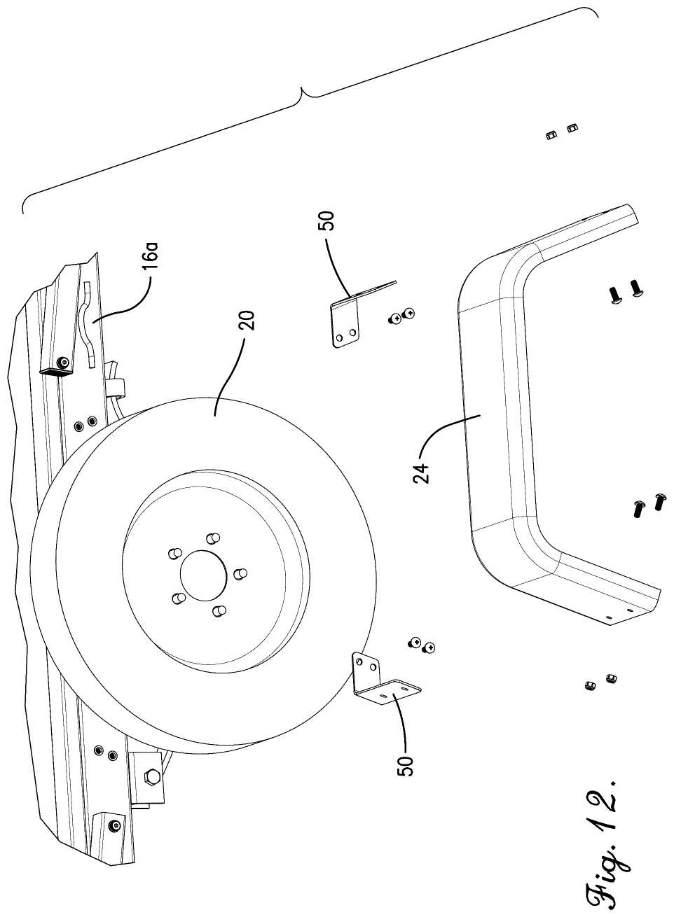

Finally, as perhaps best illustrated by FIG. 12, each of the wheel fenders 24 of the trailer 10 may be secured to a respective side frame element 16a of the base frame 16 of the trailer 10 via a pair of front and back support brackets 50. The support brackets 50 may each be formed as an L-shaped section of material (e.g., steel) secured to the base frame 16 via fasteners (e.g., threaded fasteners engaged with rivet nuts positioned within the side frame elements 16a). The support brackets 50 permit the fenders 24 to be rigidly secured to the base frame 16, while providing for the fenders 24 to be at least partly spaced apart laterally from the side frame elements 16a. The fenders 24 being spaced apart from the side frame elements 16a beneficially provides spacing for the side-rail assembly 30 to travel during shifting between the erected and collapsed configurations. Specifically, the support brackets 50 secure the fenders 24 to the base frame 16 in a manner the inhibits the fenders 24 from interfering with the movement and/or positioning of the side-rail assembly 30 during travel between and including the erected and collapsed configurations.

Although the invention has been described with reference to the one or more embodiments illustrated in the figures, it is understood that equivalents may be employed and substitutions made herein without departing from the scope of the invention as recited in the claims. For example, the above description illustrates how the crossbar 36 of a trailer's 10 side-rail assembly 30 is rigidly connected to the top rails 32, such that the crossbar 36 and the top rails 32 shift in unison between the erected and the collapsed configurations. However, in some embodiments, the crossbar 36 may not be rigidly connected to the top rails 32, but may be independently attached to the base frame 16 via one or more support elements 34. As such, the crossbar 36 and the top rails 32 may be independently shifted between the erected and the collapsed configurations.

Having thus described one or more embodiments of the invention, what is claimed as new and desired to be protected by Letters Patent includes the following:

1. A trailer comprising:
a base frame;
a side-rail assembly secured to the base frame, wherein the side-rail assembly comprises at least one top rail and at least one support element extending between the top rail and the base frame,
wherein the side-rail assembly is configured to shift between an erected configuration and a collapsed configuration,
wherein in the erected configuration, the top rail is positioned vertically above and spaced apart from the base frame,
wherein in the collapsed configuration, the the top rail is positioned adjacent to the base frame.

2. The trailer of claim 1, wherein the support element is rotatably secured to the top rail and rotatably secured to the base frame.

3. The trailer of claim 1, wherein the trailer includes a locking mechanism configured to selectively maintain the side-rail assembly in either the erected configuration or the collapsed configuration.

4. The trailer of claim 3, wherein the trailer includes a base bracket extending upward from the base frame, and wherein the locking mechanism is configured to secure the top rail to the base bracket when the side-rail assembly is in the erected configuration.

5. The trailer of claim 4, wherein the locking mechanism is configured to secure the top rail to the base frame when the side-rail assembly is in the collapsed configuration.

6. The trailer of claim 3, wherein the locking mechanism is configured to extend between the support element and the top rail when the side-rail assembly is in the erected configuration, and wherein the locking mechanism is configured to extend between the support element and the base frame when the side-rail assembly is in the collapsed configuration.

7. The trailer of claim 3, wherein the trailer includes a ramp rotatably secured to a back of the base frame, and wherein the base bracket supports a latching mechanism for selectively maintaining the ramp in a raised position.

8. The trailer of claim 3, wherein the base bracket supports a light assembly.

9. The trailer of claim 1, wherein the side-rail assembly comprises a pair of spaced apart top rails and a crossbar extending between front ends of the top rails.

10. The trailer of claim 9, wherein the base frame comprises a pair of spaced apart side frame elements and a front frame element extending between front ends of the side frame elements, wherein in the erected configuration each of the top rails is positioned directly vertically above one of the side frame elements such that the top rails are laterally and/or longitudinally aligned with the side frame elements and the crossbar is positioned directly vertically above the front frame element such that the crossbar is laterally and/or longitudinally aligned with the front frame element.

11. The trailer of claim 10, wherein in the collapsed configuration each of the top rails is positioned adjacent to one of the side frame elements and the crossbar is spaced forward from the front frame element.

12. The trailer of claim 11, wherein in the collapsed configuration each of the top rails is positioned on top of and in contact with one of the side frame elements and a bottom surface of the crossbar is generally aligned with a top surface of the front frame element.

13. The trailer of claim 1, wherein the trailer comprises a wheel fender, and wherein the wheel fender is secured to the base frame via one or more support brackets, and wherein the support brackets are configured to secure the wheel fender to the base frame such that the wheel fender is spaced laterally apart from base frame to permit the side-rail assembly to transition between the erected configuration and the collapsed configuration.

14. A trailer comprising:
a base frame;
a side-rail assembly secured to the base frame, wherein the side-rail assembly comprises at least one top rail and at least two support elements extending between the top rail and the base frame,
wherein the side-rail assembly is configured to shift between an erected configuration and a collapsed configuration,
wherein in the erected configuration, the top rail is positioned vertically above and spaced apart from the base frame,
wherein during a transition between the erected configuration and the collapsed configuration, the the top rail is configured to shift forwardly and downwardly.

15. The trailer of claim 14, wherein the support elements are each rotatably secured to the top rail and rotatably secured to the base frame.

16. The trailer of claim 14, wherein the trailer includes a locking mechanism configured to selectively maintain the side-rail assembly in either the erected configuration or the collapsed configuration.

17. The trailer of claim 14, wherein the side-rail assembly comprises a pair of spaced apart top rails and a crossbar extending between front ends of the top rails, wherein the base frame comprises a pair of spaced apart side frame elements and a front frame element extending between front ends of the side frame elements, wherein in the erected configuration each of the top rails is positioned directly vertically above one of the side frame elements and the crossbar is positioned directly vertically above the front frame element, and wherein in the collapsed configuration each of the top rails is positioned adjacent to one of the side frame elements and the crossbar is spaced forward from the front frame element.

18. A method of using a trailer, said method comprising the steps of:
(a) providing the trailer comprising a base frame and a side-rail assembly secured to the base frame, wherein the side-rail assembly comprises at least one top rail and at least one support element extending between the top rail and the base frame;
(b) maintaining the side-rail assembly in an erected configuration in which the top rail is positioned vertically above and spaced apart from the base frame; and
(c) shifting the side-rail assembly to a collapsed configuration in which the the top rail is positioned adjacent to the base frame.

19. The method of claim 18, wherein as the side-rail assembly transitions from the erected configuration to the collapsed configuration, the side-rail assembly translates forwardly and downwardly.

20. The method of claim 18, further comprising the step of nesting the trailer with one or more additional trailers for shipping.
